(19) United States
(12) Patent Application Publication
(10) Pub. No.: US 2018/0041534 A1
(43) Pub. Date: Feb. 8, 2018

(54) IT Audit Machine (ITAM)

(71) Applicant: Michael Daniel Peters, Chandler, AZ (US)

(72) Inventor: Michael Daniel Peters, Chandler, AZ (US)

(21) Appl. No.: 15/230,867

(22) Filed: Aug. 8, 2016

(51) Int. Cl. H04L 29/06

(52) U.S. Cl. CPC H04L 63/1433

(57) ABSTRACT

Disclosed is a SaaS ITAM (Information Technology Audit Machine) having state-of-art and novel online features suitable to assess cybersecurity security risk, governance, risk and compliance requirement and build forms to report and analyze entity compliance thereof, having at least one or more of the following features: a) login, b) sign-out, c) help, d) settings, e) my-account, f) my-users, g) edit themes, h) manage reports, i) manage data, j) notifications, and manage forms; with executive means of aa) forms logic, bb) create forms, cc) and edit forms, whereas said logic is executed in a novel logic-builder unit; with modules aaa) field adding, bbb) policy-machine code, and ccc) choices-and-scores, ddd) multi-form cascading; while the modules commonly enable a novel ITAM policy-machine, which, via an organization tool, enables web integration means; and while the ITAM is executed on stationary or mobile computing hardware; and while the user and admin have dual access to a multiplicity of the features, means, units, and modules.

Non-Provisional application for a patent Filed by Aug. 6, 2016

Prior Provisional application for a patent Filed by Aug. 28, 2015 U.S. PTO 62/282,905 Aug. 14, 2015

### FIELD OF THE INVENTION

This invention relates to SaaS (software as a service) for preventive cybersecurity audits, assessments and forms creation in the GRC (governance, risk and compliance) market. More specifically, to online audit machines of dual entry portals, separating user from—and connecting to—admin, while incorporating logic builder, form builder, web integration, policy machine code, multi-form cascading (linking), choice fields and scores.

### BACKGROUND OF THE INVENTION

The invention fulfills the need for more efficiency, time saving, cost reduction and human error reduction in the field of online auditing and reporting of cybersecurity GRC by proposing a novel ITAM.

Cybersecurity is paramount for the survival and striving of enterprises, agencies and governments. To safeguard the common interest, authorities mandate minimum-standard compliances, which however changing almost daily, in the apparently futile effort to keep up with the demand created by ever sophisticated and vicious attacks by adversaries fought in cyber defense (the Fifth Domain of War) and in economy.

The decades-long massive credit creation by central banks accelerated the proliferation of “too large to fail” companies, shifting their existential risk towards national security risk.

Said regulations are thus a must. Compliance with such however became a chocking point on normal operations, defying purpose. The burden of reporting is daunting. Automation thus became a must as well.

Recently, several inventors proposed methods to alleviate the burden of compliance in related fields. These may offer in part components of adaptation to cybersecurity GRC.

For instance, Leong at al. proposed automatic forms creation relating to transactions (ELECTRONIC MENU DOCUMENT CREATOR IN A VIRTUAL FINANCIAL ENVIRONMENT, U.S. Pat. No. 7,167,844 B1, Jan. 23, 2007).

DeNovo at al. disclosed “SECURITY COMPLIANCE METHODOLOGY AND TOOL” (US 2008/0282320 A1, Nov. 13, 2008) for the risk assessments of organizations to protect shareholder interests.

Inventor King proposed an “AUDIT MANAGEMENT WORKBENCH” (U.S. Pat. No. 7,899,693 B2, Mar. 1, 2011) to recognize business risk inherent in operations and structures unrelated to regulations.

Others, including Klein at al. (U.S. Pat. No. 7,664,729) offered IT architecture visualization and hierarchical modeling as a tool.

None offered however—even in part—comprehensive and integrated solution to the pressing problems stated above.

Therefore, the main object of the invention is to provide a SaaS in the GRC space, which—as a living document, continuously updated—produces cybersecurity audit documentation and compliance assessments, recommendations and reports. Furthermore, to simplify the process by using novel logic builder, form creator, web integrator, policy machine code, multi-form cascading, choices selection and scores assignments. Finally, to manage, store, update and curate pertinent regulatory codes, requirements, laws and incidental documentaries and to advise on their use and impact of ignoring such.

Traditional cybersecurity risk assessment can take up to several weeks for the manual compilation of audit and assessment data entry into a formal report. There is a high degree of human error involved in the state-of-art transcription process. It is proven that using ITAM—as proposed here—the required audit time is reduced from weeks to minutes and the resulting audit is several folds more reliable than a state-of-art manual audit alternative. Hence the time saving and economy power of the hereby disclosed ITAM.

### SUMMARY OF THE INVENTION

The above problems and others are at least partially solved and the above objects and others realized in a process, which according to the teachings of this invention, uses an ITAM (Information Technology Audit Machine), an SaaS (Software as a Service), having at least one Administrative Portal and at least one User Portal interconnected.

The User Portal has Standard Features, while the Administrative Portal has both Standard Features and Advanced Features, which includes Novel Features. These essential features with their main functionalities are listed and detailed next.

The User Portal user starts with Signing-in to the ITAM User Portal Login Page and ends with Signing-out in the User Portal, which incorporates Catalog, My Forms, My Documents, My Reports, Business Information, My Account, Sign Out and Help as Standard Features.

The Administrative Portal user starts with Signing-in to the ITAM Admin Portal Login Page and ends with Signing-out in the Admin Portal, which incorporates Manage Forms, Manage Reports, Edit Themes, My Users, My Account, Settings, Sign Out and Help as Standard Features.

The Manage My Users functionality includes a) adding users, b) editing a user, c) two-step multifactor authentication verification, d) delete or suspend a user, e) allowing a user to create new forms, f) allowing a user to create new themes, g) allowing a user to administer ITAM and h) my users main interface.

The Users Manager interface consists of a main table that displays all users with access to the user's IT Audit machine. There are options here to filter, sort, delete or suspend users as well as features to automatically suspend account after a predefined date, to automatically suspend an account for inactivity after a predefined number of days and to automatically delete the account for inactivity after a predefined number of days of inactivity which emphasize enterprise cyber security access and authentication controls.

The Manage My Account functionality includes i) profile password management, and j) two-step multifactor authentication management.

In the My Account screen, users can manage basic account and logic information, accessible from via the My Account tool on the ITAM menu.

The Manage Setting functionality includes k) use SMTP servers to send emails, l) miscellaneous settings, m) enforce two-step multifactor authentication on users, n) enable IP address restriction, o) enable account locking, p) form export-import tool, q) ITAM license management, r) enable registration notification, s) enable welcome message notification, t) enable site down, u) reCAPTCHA Site Key management, v) LDAP authentication for administrators, and w) form exporting and importing tool.

The System Settings interface allows the admin to define a variety of system-wide settings.

The Help Feature is self-explanatory.

The Administrative Portal incorporates Manage Forms, Manage Reports, Edit Themes, and Manage Data. These are also User accessible.

The Edit Theme is the ITAM's theme editor, which allows users that are granted the Create New Theme privilege the ability to customize most aspects of a forms visual appearance, which may harmonize with the customer's theme color setting and fonts, as well as other visual aspects for familiarity and branding associations.

The Manage Reports functionality includes A) line chart, B) area chart, C) column chart, D) bar chart, E) pie chart, F) scatter chart, G) bubble chart, H) dynamic chart, I) combination chart, J) 3D Chart, K) gauges, L) heat map, M) general map, and N) dynamic map.

Using the Create New Report tool, the Manage Report allows the user to create, manage and edit reports. Analysis and comparison of existing form data may be computed here and assigned to a user.

The Manage Forms primary functionalities include O) searching the forms list, P) filtering the forms list, Q) sorting forms, R) tagging forms, S) enable-disable forms, T) changing theme, U) duplicating the form, and V) deleting the form.

The Manage Forms has novel functions and operations, which will be further detailed after the description of the Manage Data. The key novel functions of the Manage Forms are, the Logic Builder, the Create-Edit Forms and the Web Integration.

The Manage Forms secondary functionalities include, W) entries, X) theme, Y) notifications, Z) code, AA) payment, BB) cancellation, CC) logic, DD) report, EE) view, FF) disable, GG) sort, HH) delete, II) duplicate, JJ) create, and KK) edit.

The Manage Forms through the ITAM Forms Manager features a multiplicity of tools for boosting forms management efficiency, especially useful for large organizations in need of numerous custom forms.

The Manage Forms through Logic (CC) leads to the Logic Builder, which is the advanced and Novel ITAM option.

The Logic Builder functionalities include, LL) enable rules to show fields, MM) enable rules to hide fields, NN) enable rules to skip pages, OO) enable rules to send notification emails, and PP) enable rules to send form data to another website.

Advanced feature of the Logic Builder are the built-in conditional logic functions for forms and pages. Logic Builder is the control window where from designers are able to define specific business rules for certain types of form and page behavior. It is accessed from the advanced features tab of the drop down menu when selecting the form. Using this feature, form designers are able to dynamically show or hide fields, based on selections being made by the user and skip to a certain page. This is useful when it is necessary to display different form content to specific users without creating multiple forms with multiple redundant fields or having a single form with large number of fields. Creating logic for a form is novel and powerful, because it does not require the user to program in any code or machine language.

The Enable Rules to Show or Hide Fields (LL-MM) is enabled to show or hide fields on the form, based on the value of other fields. It is useful for displaying different set of fields based on user choices.

The Enable Rules to Skip Pages (NN) is enabled to allow the user to jump into the success page or go to any specific page, based on their choices. It is useful when the user have a multiple page form and need to display different set of pages based on user choices.

The Enable Rules to Send Notification Emails (OO) is enabled to send additional notification emails to any email address or addresses based on user choices. The user may customize the email content, subject, and form addresses, based on user choices.

The Enable Rules to Send Form Data to Another Website (PP) is enabled to send additional web-hooks to any other URLs, based on user choices.

The Manage Forms through Create (JJ) and Edit (KK) leads to Create Forms.

An exemplary use of the Logic Builder is filling out questioner for a vendor cyber security risk management, which requires collecting specific info from a host of third-party entities, which increases the chances for human error related to attention span and fatigue. The ITAM is capable to direct the flow of the forms or pages, based on what the user entered or omitted. That shortens the questionnaire time if there is no need for an extended evaluation, or add additional response requirements if further need for that is determined. The expert system ITAM does this in real time, greatly boosting efficiency and reducing cost.

The Create-Edit Forms primary functionalities include, QQ) creating new form, RR) tagging the forms, SS) filtering and soring the forms, TT) enable and disable a form, UU) change themes, VV) duplicate the form, XX) delete the form, YY) add fields, ZZ) order fields, AAA) field properties, BBB) form properties, CCC) field guidelines, DDD) creating a multi-page form, and EEE) custom handling and formatting with HTML.

The Create-Edit Forms secondary functionalities include adding field, listing as, FFF) single line text, GGG) paragraph text, HHH) name, III) address, JJJ) phone, KKK) email, LLL) time, MMM) date, NNN) number, OOO) price, PPP) website, QQQ) multiple choice, RRR) checkboxes, SSS) matrix choice, TTT) drop down, UUU) file upload, VVV) signature, WWW) selection brake, XXX) page break, YYY) Syndication, and ZZZ) Form Cascading most which have assigned Policy Machine Code, some of which have Choices and Scores (QQQ-TTT).

The Manage Forms through Edit (KK) leads to the Multi-Form Cascading, which is an advanced and Novel ITAM option.

An exemplary use of the Novel Multi-Form Cascading form field is allowing form designers and administrators to ability to connect multiple forms together rendering them as one contiguous form to the User in real time, which allows for cost and complexity reductions simultaneously improving the updateability across the entire ITAM platform and User community.

The Multi-Form Cascading primary functionalities include the form designers placing the field into position and designating the unique form identification number into the field activating the connecting of multiple forms to appear as one continuous form. The data sets from User inputs continue to be maintained in their respective form databases.

The Manage Forms through Edit (KK) leads to the Choices and Scores, which is an advanced and Novel ITAM option.

Within the Form Manager Form Creation tool are the fields available to the creation of a form. Every field that would be considered “question” category includes a unique ability to assign a numeric score or weight to the response made ultimately by the form user in real-time.

The four choice fields (QQQ-TTT) work on the question field option as follows:
The Multiple Choice (QQQ) requires the selection of one response among the presented options.
The Checkboxes (RRR) allow multiple choices among the presented options.
The Matrix Choice (SSS) allows for multiple choices among the presented options.
The Drop Down (TTT) requires the selection of one response among the presented options.

Once inside the choice filed, the forms designer makes their selection as allowed. Using the (+) or (−) buttons, to add or delete choices, the form designer clicks on the choice to make it the default selection. Said designer must enter a numeric value between 0-999 in the field adjacent to the response that may be used for risk weighing and other analytical calculation of choice.

An exemplary use would be cyber security risk assessment, which requires the collection and calculation of weighted values assigned to risk factors. That is traditionally done by human assessor prone to subjective evaluations, errors and omissions. That may induce unwarranted organizational fear or unjustified organizational comfort of fear from or not worrying about grave errors, leading to delays and procrastinations. The ITAM solves this problem in minutes reliably and accurately. The risk metric is then computed in real-time for the organization utilizing a multiplicity of default report formats. That unique process boosts efficiencies exponentially and reduces cost dramatically.

The Create-Edit Forms enables the ITAM Policy Machine, which leads to the Web Integration.

The Manage Forms through Edit (KK) leads to the Policy Machine Code, which is an advanced and Novel ITAM option.

The user can add a custom variable to the parent element of the majority of form fields, which is useful when the user wishes to generate ITAM Policy Machine reports and documents using ITAM form data. These custom Policy Machine codes appear live in the form builder, but do not appear on the live form when displayed to the production User. The user data then populates the custom document templates assigned to the respective form and automatically generates a new document or documents.

An exemplary example would cite again the cyber security risk assessment, which traditionally requires several weeks of manual compilation of audit and assessment date into the formal report. There is a high degree of human error involved in this with hours long and tiresome transcription process. The ITAM does all this in minutes accurately and reliably in real-time, securing a previously unheard-of efficiency and economy.

The administrators and users with permissions to create new forms begin form creation at the Form Manager page and launch the Form Builder tool. The Form Builder allows the user to select and place form design elements or fields from a multiplicity of predefined field type elements, define specific properties, including form-specific properties. Upon saving the design of a new form, the user is redirected back to the Form Manager page and the new form is displayed in the list of available forms.

The Web Integration functionalities include, BBBB) JavaScript Code, CCCC) Iframe Code, DDDD) PHP Embedded Code, EEEE) PHP Form File Code, FFFF) Simple Link Code, and GGGG) Popup Link Code.

The IT Audit Machine creates forms that can be integrated into an organization's existing websites and web applications. Through the use of multiple embedded code options, administrators are able to easily deploy an ITAM form from within an existing website, utilizing familiar coding methods without the need of advanced coding techniques. The user can access the Form Code interface by selecting a form from the Form Manager and then selecting the Code button on the tab below the selected form.

The Manage Data functionality includes HHHH) view entry detail, IIII) edit entry, JJJJ) forward entry, KKKK) filter entry, LLLL) display selected fields, and MMMM) export entries.

Using the Entry Manager, the Manage Data saves all user submitted data automatically. Entries (database records) can be managed within ITAM via the Entry Manager. The Admin Portal submitted forms will generate a new database record that may be viewed within the Admin View function, whereas the User Portal is collaborative, based on a single database entry, made and updated with each form submission for as long as the user is subscribed to that specific form. This allows group collaboration of updating a single form with the User Portal and individual assessment by administrators from the Admin Portal form viewer.

The last Novel Feature is the ITAM Notifications, with functionalities of NNNN) email notification, OOOO) notification settings interface, PPPP) customizing the basic email options, and QQQQ) customizing the subject and content.

Each form created in ITAM allows for form-specific email notification or confirmation upon successful submission of a record entry using the specified form. This is a powerful feature. Administrators and Form Designers have the ability to customize several email notification parameters. Access to a forms email notification is provided via the notification button or tab below the form entry in the Form Manager.

The typical use of the disclosed ITAM includes Cyber Security assessments and evaluations, Audit and Compliance Assessments associated with FedRAMP, PCI DSS, HIPAA, Sarbanes Oxley, ISO 27001 SSAE 16 and all others in circulation, Risk Management Assessment associated with ISO 27005, NIST Special Publications and all others in circulation, and Governance and Policy Development, and more.

### BRIEF DESCRIPTION OF THE DRAWINGS

Referring to the drawings:

FIG. 1 is a diagrammatic structure of an exemplary ITAM as per the teachings of the invention.

FIG. 2 is diagram illustrating the double access security feature of the exemplary embodiment of FIG. 1.

FIG. 3 is the registration number from the return notification of the prior Provisional application for a patent Filed by Aug. 28, 2015 U.S. PTO 62/282,905 Aug. 14, 2015.

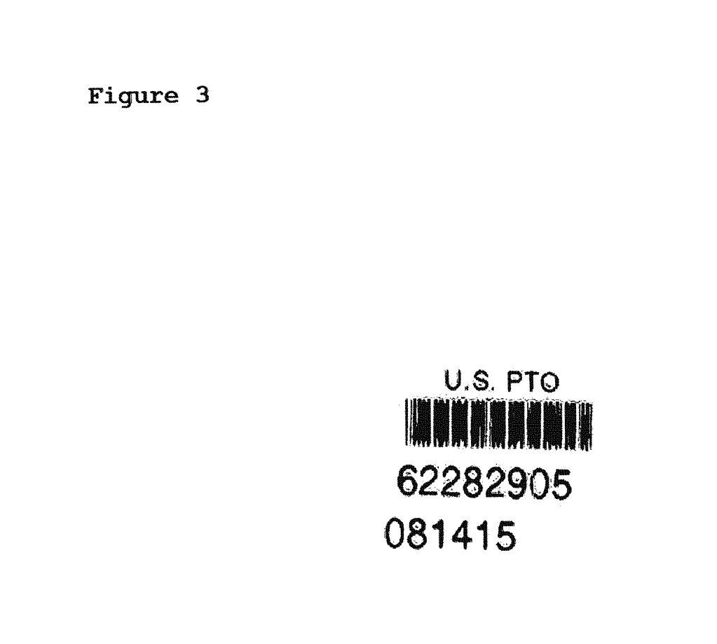

### DETAILED DESCRIPTION OF A PREFERRED EMBODIMENT

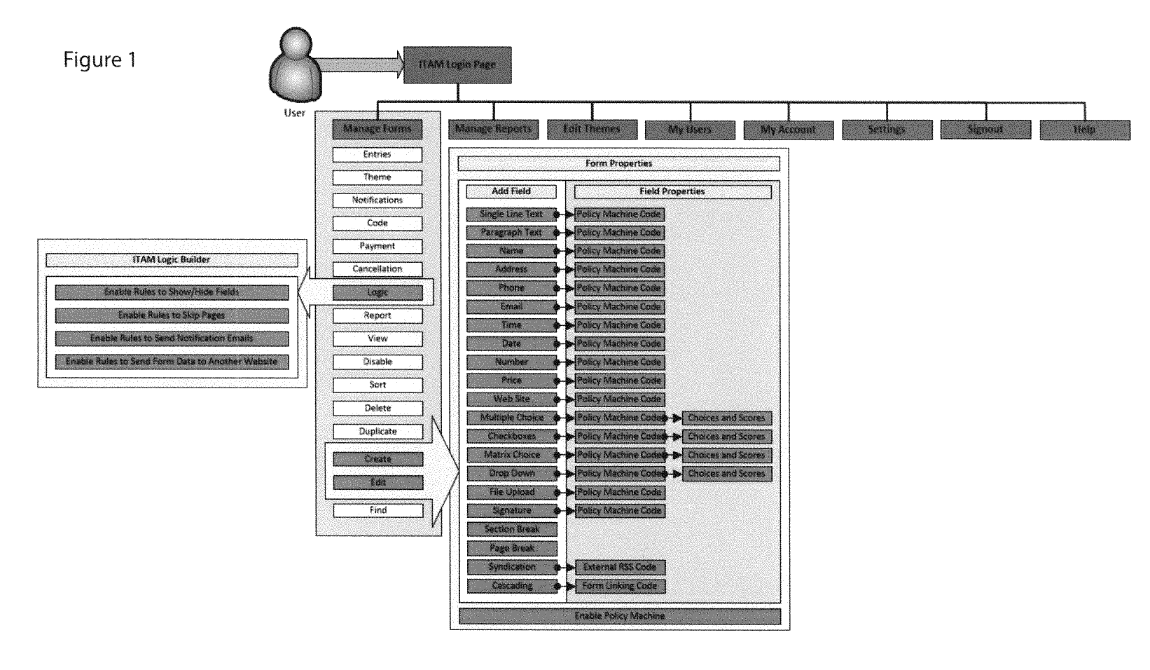

Attention is now turned to FIG. 1, which is a diagram illustrating the structure of an exemplary ITAM (Information Technology Audit Machine) as per the teachings of the invention, with emphasis on the two-way access—through Admin Portal and User portal—of its forms creation engine.

The User Portal has Standard Features, while the Administrative Portal has both Standard Features and Advanced Features, which includes Novel Features. These essential features with their main functionalities are listed and detailed next.

The User Portal user starts with Signing-in to the ITAM User Portal Login Page and ends with Signing-out in the User Portal, which incorporates Catalog, My Forms, My Documents, My Reports, Business Information, My Account, Sign Out and Help as Standard Features.

The Administrative Portal user starts with Signing-in to the ITAM Admin Portal Login Page and ends with Signing-out in the Admin Portal, which incorporates Manage Forms, Manage Reports, Edit Themes, My Users, My Account, Settings, Sign Out and Help as Standard Features.

The Manage My Users functionality includes a) adding users, b) editing a user, c) two-step multifactor authentication verification, d) delete or suspend a user, e) allowing a user to create new forms, f) allowing a user to create new themes, g) allowing a user to administer ITAM and h) my users main interface.

The Users Manager interface consists of a main table that displays all users with access to the user's IT Audit machine. There are options here to filter, sort, delete or suspend users as well as features to automatically suspend account after a predefined date, to automatically suspend an account for inactivity after a predefined number of days and to automatically delete the account for inactivity after a predefined number of days of inactivity which emphasize enterprise cyber security access and authentication controls.

The Manage My Account functionality includes i) profile password management, and j) two-step multifactor authentication management.

In the My Account screen, users can manage basic account and logic information, accessible from via the My Account tool on the ITAM menu.

The Manage Setting functionality includes k) use SMTP servers to send emails, l) miscellaneous settings, m) enforce two-step multifactor authentication on users, n) enable IP address restriction, o) enable account locking, p) form export-import tool, q) ITAM license management, r) enable registration notification, s) enable welcome message notification, t) enable site down, u) reCAPTCHA Site Key management, v) LDAP authentication for administrators, and w) form exporting and importing tool.

The System Settings interface allows the admin to define a variety of system-wide settings.

The Help Feature is self-explanatory.

The Administrative Portal incorporates Edit Themes, Manage Reports, Manage Forms, and Manage Data. These are also User accessible.

The Edit Theme is the ITAM's theme editor, which allows users that are granted the Create New Theme privilege the ability to customize most aspects of a forms visual appearance, which may harmonize with the customer's theme color setting and fonts, as well as other visual aspects for familiarity and branding associations.

The Manage Reports functionality includes A) line chart, B) area chart, C) column chart, D) bar chart, E) pie chart, F) scatter chart, G) bubble chart, H) dynamic chart, I) combination chart, J) 3D Chart, K) gauges, L) heat map, M) general map, and N) dynamic map.

Using the Create New Report tool, the Manage Report allows the user to create, manage and edit reports. Analysis and comparison of existing form data may be computed here and assigned to a user.

The Manage Forms primary functionalities include O) searching the forms list, P) filtering the forms list, Q) sorting forms, R) tagging forms, S) enable-disable forms, T) changing theme, U) duplicating the form, and V) deleting the form.

The Manage Forms has novel functions and operations, which will be further detailed after the description of the Manage Data. The key novel functions of the Manage Forms are, the Logic Builder, the Create-Edit Forms, and the Web Integration.

The Manage Forms secondary functionalities include, W) entries, X) theme, Y) notifications, Z) code, AA) payment, BB) cancellation, CC) logic, DD) report, EE) view, FF) disable, GG) sort, HH) delete, II) duplicate, JJ) create, and KK) edit.

The Manage Forms through the ITAM Forms Manager features a multiplicity of tools for boosting forms management efficiency, especially useful for large organizations in need of numerous custom forms.

The Manage Forms through Logic (CC) leads to the Logic Builder, which is the advanced and Novel ITAM option.

The Logic Builder functionalities include, LL) enable rules to show fields, MM) enable rules to hide fields, NN) enable rules to skip pages, OO) enable rules to send notification emails, and PP) enable rules to send form data to another website.

Advanced feature of the Logic Builder are the built-in conditional logic functions for forms and pages. Logic Builder is the control window where from designer are able to define specific business rules for certain types of form and page behavior. It is accessed from the advanced features tab of the drop down menu when selecting the form. Using this feature, form designers are able to dynamically show or hide fields, based on selections being made by the user and skip to a certain page. This is useful when it is necessary to display different form content to specific users without creating multiple forms with multiple redundant fields or having a single form with large number of fields. Creating logic for a form is novel and powerful, because it does not require the user to program in any code or machine language.

The Enable Rules to Show or Hide Fields (LL-MM) is enabled to show or hide fields on the form, based on the value of other fields. It is useful for displaying different set of fields based on user choices.

The Enable Rules to Skip Pages (NN) is enabled to allow the user to jump into the success page or go to any specific page, based on their choices. It is useful when the user have a multiple page form and need to display different set of pages based on user choices.

The Enable Rules to Send Notification Emails (OO) is enabled to send additional notification emails to any email address or addresses based on user choices. The user may customize the email content, subject, and form addresses, based on user choices.

The Enable Rules to Send Form Data to Another Website (PP) is enabled to send additional web-hooks to any other URLs, based on user choices.

The Manage Forms through Create (JJ) and Edit (KK) leads to Create Forms.

The Create-Edit Forms primary functionalities include, QQ) creating new form, RR) tagging the forms, SS) filtering and soring the forms, TT) enable and disable a form, UU) change themes, VV) duplicate the form, XX) delete the form, YY) add fields, ZZ) order fields, AAA) field properties, BBB) form properties, CCC) field guidelines, DDD) creating a multi-page form, and EEE) custom handling and formatting with HTML.

The Create-Edit Forms secondary functionalities include adding field, listing as, FFF) single line text, GGG) paragraph text, HHH) name, III) address, JJJ) phone, KKK) email, LLL) time, MMM) date, NNN) number, OOO) price, PPP) website, QQQ) multiple choice, RRR) checkboxes, SSS) matrix choice, TTT) drop down, UUU) file upload, VVV) signature, WWW) selection brake, XXX) page break, YYY) Syndication, ZZZ) Form Cascading, most of which have assigned Policy Machine Codes, some of which have Choices and Scores (QQQ-TTT).

The Manage Forms through Edit (KK) leads to the Multi-Form Cascading, which is an advanced and Novel ITAM option.

The Multi-Form Cascading primary functionalities include the form designers placing the field into position and designating the unique form identification number into the field activating the connecting of multiple forms to appear as one continuous form. The data sets from User inputs continue to be maintained in their respective form databases.

The Manage Forms through Edit (KK) leads to the Choices and Scores, which is an advanced and Novel ITAM option.

Within the Form Manager Form Creation tool are the fields available to the creation of a form. Every field that would be considered “question” category includes a unique ability to assign a numeric score or weight to the response made ultimately by the form user in real-time.

The four choice fields (QQQ-TTT) work on the question field option as follows:
The Multiple Choice (QQQ) requires the selection of one response among the presented options.
The Checkboxes (RRR) allow multiple choices among the presented options.
The Matrix Choice (SSS) allows for multiple choices among the presented options.
The Drop Down (TTT) requires the selection of one response among the presented options.

Once inside the choice filed, the forms designer makes their selection as allowed. Using the (+) or (−) buttons, to add or delete choices, the form designer clicks on the choice to make it the default selection. Said designer must enter a numeric value between 0-999 in the field adjacent to the response that may be used for risk weighing and other analytical calculation of choice.

The Create-Edit Forms enables the ITAM Policy Machine, which leads to the Web Integration.

The Manage Forms through Edit (KK) leads to the Policy Machine Code, which is an advanced and Novel ITAM option.

The user can add a custom variable to the parent element of the majority of form fields, which is useful when the user wishes to generate ITAM Policy Machine reports and documents using ITAM form data. These custom Policy Machine codes appear live in the form builder, but do not appear on the live form when displayed to the production User. The user data then populates the custom document templates assigned to the respective form and automatically generates a new document or documents.

The administrators and users with permissions to create new forms begin form creation at the Form Manager page and launch the Form Builder tool. The Form Builder allows the user to select and place form design elements from a multiplicity of predefined field type elements, define specific properties, including form-specific properties. Upon saving the design of a new form, the user is redirected back to the Form Manager page and the new form is displayed in the list of available forms.

The Web Integration functionalities include, BBBB) JavaScript Code, CCCC) Iframe Code, DDDD) PHP Embedded Code, EEEE) PHP Form File Code, FFFF) Simple Link Code, and GGGG) Popup Link Code.

The IT Audit Machine creates forms that can be integrated into an organization's existing websites and web applications. Through the use of multiple embedded code options, administrators are able to easily deploy an ITAM form from within an existing website, utilizing familiar coding methods without the need of advanced coding techniques. The user can access the Form Code interface by selecting a form from the Form Manager and then selecting the Code button on the tab below the selected form.

The Manage Data functionality includes HHRH) view entry detail, IIII) edit entry, JJJJ) forward entry, KKKK) filter entry, LLLL) display selected fields, and MMMM) export entries.

Using the Entry Manager, the Manage Data saves all user submitted data automatically. Entries (database records) can be managed within ITAM via the Entry Manager. The Admin Portal submitted forms will generate a new database record that may be viewed within the Admin View function, whereas the User Portal is collaborative, based on a single database entry, made and updated with each form submission for as long as the user is subscribed to that specific form. This allows group collaboration of updating a single form with the User Portal and individual assessment by administrators from the Admin Portal form viewer.

The last Novel Feature is the ITAM Notifications, with functionalities of NNNN) email notification, OOOO) notification settings interface, PPPP) customizing the basic email options, and QQQQ) customizing the subject and content.

Each form created in ITAM allows for form-specific email notification or confirmation upon successful submission of a record entry using the specified form. This is a powerful feature. Administrators and Form Designers have the ability to customize several email notification parameters. Access to a forms email notification is provided via the notification button or tab below the form entry in the Form Manager.

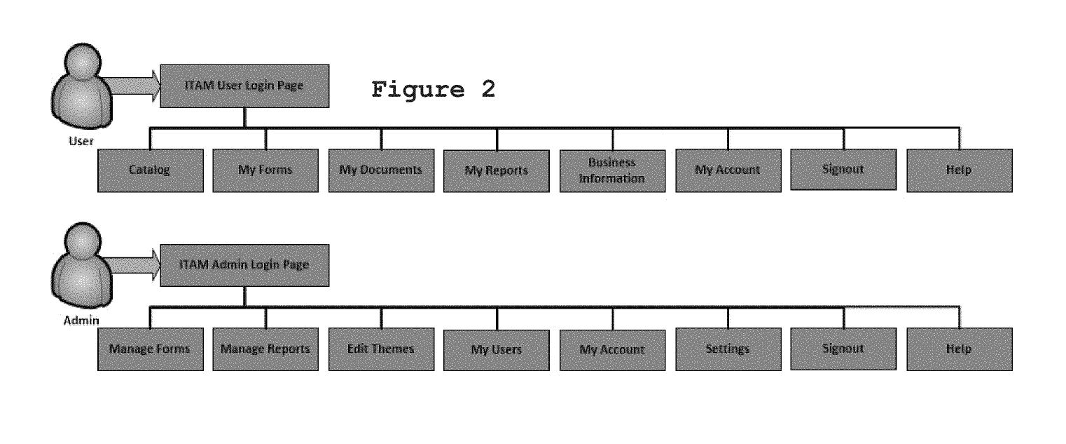

Attention is finally turned to FIG. 2, which is diagram illustrating the double access security feature of the exemplary embodiment of FIG. 1, whereas the segregated Users Portal and Admin Portal access to ITAM though the Internet SaaS (Cloud) platform across firewalls, intrusion prevention technology, two-step multifactor authentication access controls, assigned role based access security groups, private VLAN network segmentation using servers assigned to Production, Demonstration, Clients, Development, Quality Assurance and Databases. The code numbers are given only for illustration of the massive parallel coupling, which ensures robustness and speed.

The ITAM is a SaaS executed on computing hardware—stationary or mobile—which is capable to process software instructions and data.

The present invention is described above with reference to a preferred embodiment. However, those skilled in the art will recognize that changes and modifications may be made in the described embodiment without departing from the nature and scope of the present invention. For instance, the use of the disclosed ITAM structured as per FIG. 1 for other audits, which may not even related to IT is intuitive, thus hereby instructive and considered to be within the scope of this invention. Incorporating the regulations and related information management and curation into the structure illustrated in FIG. 1 is also considered to be within the scope for being obvious, yet unessential modifications.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. SaaS (Software as a Service) ITAM (Information Technology Audit Machine) structured as per FIG. 1, comprising at least one of the following features:
a) login, b) sign-out, c) help, d) settings, e) my-account, f) my-users, g) edit themes, h) manage reports, i) manage data, j) notifications, and manage forms, which comprises at least one of the following functions executing means:
aa) forms logic, bb) create forms, cc) and edit forms, whereas said logic is executed in a logic builder unit, and whereas said create and edit forms are executed in a form builder unit, having at least one of the following modules:
aaa) field adding, bbb) policy machine code, and ccc) choices-and-scores, and ddd) multi-form cascading whereas said modules commonly enable the ITAM policy machine, which, via an organization tool, enables at least one web integration means, whereas said ITAM is executed on computing hardware of at least one of the following type:
A) stationary, and B) mobile, whereas user and admin have at least one common access to a multiplicity of said features, means, units, modules and types.

2. SaaS as per claim 1, comprising a multiplicity of said features, means, units, modules and types.

3. Online method to audit and assess security risk and build forms to report and analyze entity compliance thereof using SaaS ITAM as structured per FIG. 1, comprising at least one of the following features:
a) login, b) sign-out, c) help, d) settings, e) my-account, f) my-users, g) edit themes, h) manage reports, i) manage data, j) notifications, and k) manage forms, which comprises at least one of the following functions executing means:
aa) forms logic, bb) create forms, cc) and edit forms, whereas said logic is executed in a logic builder unit, and whereas said create and edit forms are executed in a form builder unit, having at least one of the following modules:
aaa) field adding, bbb) policy machine code, and ccc) choices-and-scores, ddd) multi-form cascading whereas said modules commonly enable the ITAM policy machine, which, via an organization tool, enables at least one web integration means, whereas said ITAM is executed on computing hardware of at least one of the following type:
A) stationary, and B) mobile, whereas user and admin have at least one common access to a multiplicity of said features, means, units, modules and types.

4. Method as per claim 3, comprising a multiplicity of said features, means, units, modules and types.

5. This Non-Provisional application for a patent Filed by Aug. 6, 2016 references the Prior Provisional application for a patent Filed by Aug. 28, 2015 U.S. PTO 62/282,905 Aug. 14, 2015.
